(19) United States
(12) Patent Application Publication
(10) Pub. No.: US 2021/0048815 A1
(43) Pub. Date: Feb. 18, 2021

(54) METHOD AND APPARATUS FOR METHOD FOR PREDICTING AUTOMATED DRIVING SYSTEM DISENGAGEMENT

(71) Applicant: GM GLOBAL TECHNOLOGY OPERATIONS LLC, Detroit, MI (US)

(72) Inventors: Donal B. McErlean, Co. Clare (IE); Matthew K. Titsworth, Austin, TX (US); Mason D. Gemar, Cedar Park, TX (US); Rajesh Ayyalasomayajula, Austin, TX (US); Brett Hallum, Round Rock, TX (US)

(73) Assignee: GM GLOBAL TECHNOLOGY OPERATIONS LLC, Detroit, MI (US)

(21) Appl. No.: 16/542,812

(22) Filed: Aug. 16, 2019

(51) Int. Cl. G05D 1/00; G05D 1/02; B60W 50/14

(52) U.S. Cl. CPC G05D 1/0061; G05D 1/0221; G01C 21/20; B60W 50/14; G05D 2201/0213; G05D 1/0088

(57) ABSTRACT

The present application relates to predicting an automated driving system disengagement for a motor vehicle by calculating a route between a host vehicle location and a destination, segmenting the route into at least a first route segment and a second route segment, generating a first motion path for the first route segment and controlling the host vehicle over the first route segment, generating a second motion path for the second route segment and simulating a simulated host vehicle operation over the second route segment, predicting a disengagement event in response to the simulated host vehicle operation over the second route segment, and providing a driver alert indicative of the disengagement event while controlling the host vehicle over the first route segment.

### BACKGROUND

The present disclosure relates generally to programming motor vehicle control systems. More specifically, aspects of this disclosure relate to systems, methods and devices for providing a prediction of a transition of an automated driving system operating state to generate a driver warning in advance of a driver take over request.

The operation of modern vehicles is becoming more automated, i.e. able to provide driving control with less and less driver intervention. Vehicle automation has been categorized into numerical levels ranging from zero, corresponding to no automation with full human control, to five, corresponding to full automation with no human control. Various advanced driver-assistance systems (ADAS), such as cruise control, adaptive cruise control, and parking assistance systems correspond to lower automation levels, while true “driverless” vehicles correspond to higher automation levels.

Certain levels of ADAS systems, such as level one and level two, may require a driver to take over operation of a vehicle under certain conditions. Take over requests may be generated in response to events such as entering a construction site, merging or exiting a freeway, loss of road markings, or presence of extreme weather conditions. To safely reengage into vehicle control, drivers need time to recognize the request, return hands to steering wheel, return feet to pedals, and the gain awareness of the driving situation. Under certain circumstances, this reengagement may take up to 12-15 seconds. It would be desirable to overcome these problems to provide a method and apparatus for enabling the systems to warn the driver well in advance to reduce the likelihood of a hand-over issue.

The above information disclosed in this background section is only for enhancement of understanding of the background of the invention and therefore it may contain information that does not form the prior art that is already known in this country to a person of ordinary skill in the art.

### SUMMARY

Disclosed herein are autonomous vehicle control system training systems and related control logic for provisioning autonomous vehicle control, methods for making and methods for operating such systems, and motor vehicles equipped with onboard control systems. By way of example, and not limitation, there is presented an automobile with onboard vehicle control learning and control systems.

In accordance with an aspect of the present invention, an apparatus including a receiver operative to receive a data indicative of an assisted driving system disengagement event provided by a first vehicle, a processor operative to simulate an assisted driving system algorithm over a second route segment to generate a simulation result, the processor being further operative to predict a predicted disengagement event within the second route segment in response to the data and the simulation result and to generate a warning control signal in response to the predicted disengagement event, and a user interface to display a user alert of the predicted disengagement event in response to the warning control signal before the host vehicle reaches the second route segment.

In accordance with another aspect of the present invention wherein the predicted disengagement event is predicted using a factorial hidden Markov model.

In accordance with another aspect of the present invention wherein the predicted disengagement event is predicted using a factorial hidden Markov model using the data and a current observation data from the vehicle controller.

In accordance with another aspect of the present invention a vehicle controller operative to control a host vehicle over a first route segment.

In accordance with another aspect of the present invention wherein the processor is further operative to generate a route in response to a destination and a host vehicle location and to determine the first route segment and the second route segment in response to the route and to generate a first motion path in response to the first route segment and to couple the first motion path to the vehicle controller for controlling the vehicle over the first route segment.

In accordance with another aspect of the present invention wherein the processor is further operative to prevent an engagement of an assisted driving function during the second route segment in response to the predicted disengagement event.

In accordance with another aspect of the present invention wherein the data indicative of the assisted driving system disengagement event is determined in response to a driver take over event provided by the first vehicle.

In accordance with another aspect of the present invention a method performed by a processor including calculating a route between a host vehicle location and a destination, segmenting the route into at least a first route segment and a second route segment, generating a first motion path for the first route segment and controlling the host vehicle over the first route segment, generating a second motion path for the second route segment and simulating a simulated host vehicle operation over the second route segment, predicting a disengagement event in response to the simulated host vehicle operation over the second route segment, and providing a driver alert indicative of the disengagement event while controlling the host vehicle over the first route segment.

In accordance with another aspect of the present invention wherein the driver alert is indicative of a location of the disengagement event.

In accordance with another aspect of the present invention wherein the driver alert is indicative of a probability of the disengagement event.

In accordance with another aspect of the present invention wherein the predicting of the disengagement event is performed by determining a probability of the disengagement event and comparing the probability to a threshold level wherein the probability exceeds the threshold level.

In accordance with another aspect of the present invention including receiving an event data indicative of a prior disengagement event within the second route segment and wherein the disengagement event is predicted in response to the prior disengagement event, the host vehicle location and a host vehicle speed.

In accordance with another aspect of the present invention wherein the disengagement event is predicted in response to a factorial hidden Markov model and the host vehicle location and a host vehicle speed.

In accordance with another aspect of the present invention wherein the controlling the host vehicle over the first route segment is performed in response to the first motion path and an advanced driving assistance system algorithm.

In accordance with another aspect of the present invention wherein the disengagement event is predicted in response to a factorial hidden Markov model generated in response to a plurality of prior disengagement events within the second route segment.

In accordance with another aspect of the present invention wherein the predicting of the disengagement event is performed in response to a map data, the host vehicle location, and a host vehicle speed.

In accordance with another aspect of the present invention wherein a location of the second route segment is determined in response to the host vehicle location and a host vehicle speed.

In accordance with another aspect of the present invention an advanced driver assistance system for controlling a host vehicle including a vehicle controller to control a host vehicle in response to a first motion path, a receiver operative to receive a simulation model for simulating a second motion path, a processor for determining a first route segment and a second route segment, for generating the first motion path in response to the first route segment, for simulating the second motion path according to the simulation model to generate a disengagement probability and for predicting a disengagement event in response the disengagement probability, and for generating an alert signal in response to the disengagement probability, and a user interface for provide a disengagement warning to a host vehicle operator in response to the alert signal wherein the disengagement warning is indicative of the disengagement probability and a location of the second route segment.

In accordance with another aspect of the present invention wherein the simulation model is a factorial hidden Markov model and the disengagement probability is predicted in response to the factorial hidden Markov model generated in response to a plurality of prior disengagement events within the second route segment.

In accordance with another aspect of the present invention wherein the simulation model is indicative of a prior disengagement event within the second route segment and wherein the disengagement probability is predicted in response to the prior disengagement event, a host vehicle location and a host vehicle speed.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings.

FIG. 1 shows an operating environment for predicting automated driving system disengagement for a motor vehicle according to an exemplary embodiment.

FIG. 2 shows a block diagram illustrating a system for predicting automated driving system disengagement for a motor vehicle according to an exemplary embodiment.

FIG. 3 shows a flow chart illustrating a method for predicting automated driving system disengagement for a motor vehicle according to another exemplary embodiment.

FIG. 4 shows a block diagram illustrating a system for predicting automated driving system disengagement for a motor vehicle according to another exemplary embodiment.

FIG. 5 shows a flow chart illustrating a method for predicting automated driving system disengagement for a motor vehicle according to another exemplary embodiment.

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

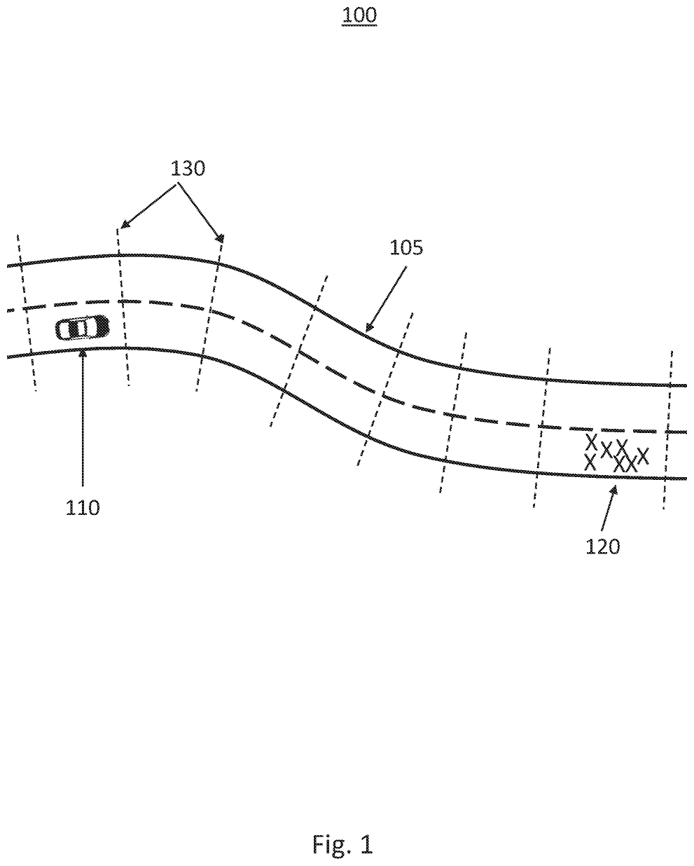

FIG. 1 schematically illustrates an operating environment 100 for predicting automated driving system disengagement for a motor vehicle 110. In this exemplary embodiment of the present disclosure, the host vehicle 110 is driving on a multilane roadway 105. An ADAS is operative to segment the roadway 105 into a number of segments wherein the segments are illustrated between segment dividers 130. The exemplary embodiment further shows a number of disengagement points where previous systems have experienced ADAS disengagement events.

The ADAS is operative to perform a methodology to predict a future state of an automatic driving system to provide drivers with early feedback and improve the usage experience. The methodology may be further operative to predict disengagements to prevent the system from being engaged in uncertain conditions. Predicting when disengagement events may occur may improve ADAS state analytics dynamic path and speed profile shaping in an ADAS equipped motor vehicle. The methodology may use a model trained using the crowdsourced data collected from automated driving fleet, finding micro patterns at road segment level, and macro patterns independent of location. The method may then simulate the vehicle driving in future segments of the predicted vehicle path, calculating a state transition score for each of the segments.

Factorial formulation allows for inference on road segments which have not previously been encountered. For example, Factorial Hidden Markov Models (FHMM) may be employed by treating sequences of individual feature states, such as traffic, weather, construction, and/or road segment, as dependent only on the previous state of that feature and the current observation as dependent only on the current state of all features. FHMM allows for distributed representation of features and allows for prediction even when data is incomplete, such as when driving on a previously un-recorded road segment or in unknown weather conditions. This Bayesian approach allows for inherent capture of uncertainty due to missing or incomplete information. The output of an FHMM includes information about the level of confidence the model has in any prediction by leveraging current state observations to determine likely future states. Given a prediction of disengagement, a notification may be provided in advance of potential incident to request to the driver to takeover. For example, if the method determines that a disengagement is likely within a certain distance, e. g. 2-3 km, the driver is notified so that disengagement runs smoothly. In the instance where the ADAS is not engaged, the method may then prevent the driver from engaging over the problematic road segments.

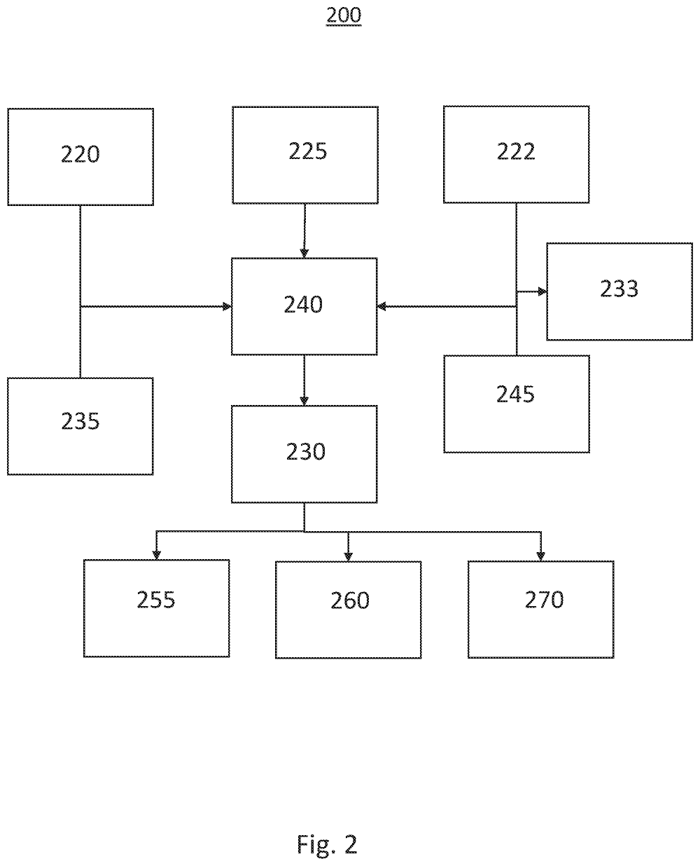

Turning now to FIG. 2, a block diagram illustrating an exemplary implementation of a system 200 for predicting automated driving system disengagement for a motor vehicle is shown. The system 200 includes a processor 240, a camera 220, a Lidar 222, a global positioning system (GPS) 225, a transceiver 233, a user interface 235, a memory 245, a vehicle controller 230 a throttle controller 255, a brake controller 260 and a steering controller 270.

During ADAS operation, the system 200 is operative to use various sensors such as a camera 220, IMU 233 and Lidar 222 capable of identifying and locating roadway markers, proximate vehicles and other external objects. Sensor fusion algorithms provide accurate tracking of external objects as well as calculation of appropriate attributes such as relative velocities, accelerations, and the like. The camera 220 is operative to capture an image of a field of view (FOV) which may include static and dynamic objects proximate to the vehicle. Image processing techniques may be used to identify and locate objects within the FOV. The identification and location of these objects and the surrounding environment may facilitate the creation of a three dimensional object map by the ADAS in order to control the vehicle in the changing environment.

The Lidar 222 is operative to generate a laser beam, transmit the laser beam into the FOV and capture energy reflected from a target. The Lidar 222 may employ time-of-flight to determine the distance of objects from which the pulsed laser beams are reflected. The oscillating light signal is reflected from the object and is detected by the detector within the Lidar 222 with a phase shift that depends on the distance that the object is from the sensor. An electronic phase lock loop (PLL) may be used to extract the phase shift from the signal and that phase shift is translated to a distance by known techniques.

The Lidar 222 may be employed as a sensor on the host vehicle to detect objects around the vehicle and provide a range to and orientation of those objects using reflections from the objects providing multiple scan points that combine as a point cluster range map, where a separate scan point is provided for every ½° or less across the field-of-view (FOV) of the sensor. Therefore, if a target vehicle or other object is detected in front of the subject vehicle, there may be multiple scan points that are returned that identify the distance of the target vehicle from the subject vehicle. By providing a cluster of scan return points, objects having various and arbitrary shapes, such as trucks, trailers, bicycle, pedestrian, guard rail, etc., can be more readily detected, where the bigger and/or closer the object to the subject vehicle the more scan points are provided.

The user interface 235 may be a user input device, such as a display screen, light emitting diode, audible alarm or haptic seat located in the vehicle cabin and accessible to the driver. Alternatively, the user interface 235 may be a program running on an electronic device, such as a mobile phone, and in communication with the vehicle, such as via a wireless network. The user interface 235 is operative to collect instructions from a vehicle operator such as initiation and selection of an ADAS function, desired following distance for adaptive cruise operations, selection of vehicle motion profiles for assisted driving, etc. In response to a selection by the vehicle operator, the user interface 235 may be operative to couple a control signal or the like to the processor 240 for activation of the ADAS function. Further, the user interface may be operative to provide a user prompt or warning indicative of an upcoming potential disengagement event of the ADAS and/or a request for the user to take over control of the vehicle.

The transceiver 233 is operative to transmit and receive data via a wireless network to a server, such as a central server or a cloud server. The transmitted data may include instances and locations where a disengagement event has occurred during ADAS operation. This data may be transmitted by the transceiver 233 in response to a request from the server, periodically, or after one or more disengagement events. The transceiver may be further operative to receive data from the server indicative of locations of disengagement events, other ADAS operating state transitions, and/or other crowdsourced data, such as weather, road conditions, obstacles, obstructions, construction sites, traffic and the like which may be used to predict an ADAS state transition, such as a disengagement event.

In an exemplary embodiment, the processor 240 is operative to receive the data from the transceiver 233 and to perform the ADAS operating state transition prediction algorithm. The processor 240 simulates control of the vehicle traversing a number of upcoming route segments to be navigated by the vehicle during ADAS operation. The number of route segments may be determined dynamically in response to speed and distance to the road segments. In response to the simulation, the processor is operative to generate a score indicative of a probability of a disengagement event. If the probability of a disengagement event exceeds a threshold value, wherein the threshold value is indicative of a probability high enough to alert the vehicle operator, a user prompt or warning is generated and coupled to the user interface 235. For example, if the processor 240 determines that a disengagement event is likely within a certain distance, such as 2-3 km, the user prompt may be provided to the user interface 235 so that disengagement runs smoothly and the vehicle operator has enough time to safely reengage with the vehicle control. If an ADAS system is not engaged, the processor 240 may prevent the ADAS system from being engaged over the problematic road segments. Exemplary data used in predicting a disengagement event for a segment may include road segment entry time, location, vehicle speed, map version, weather and ambient traffic. This data may be provided to a learnt road segment model to generate the score indicative of a probability of a disengagement event.

The vehicle controller 230 may generate control signals for coupling to other vehicle system controllers, such as a throttle controller 255, a brake controller 260 and a steering controller 270 in order to control the operation of the vehicle in response to the ADAS algorithm. The vehicle controller may be operative to adjust the speed of the vehicle by reducing the throttle via the throttle controller 255 or to apply the friction brakes via the brake controller 260 in response to a control signals generated by the processor 240. The vehicle controller may be operative to adjust the direction of the vehicle controlling the vehicle steering via the steering controller 270 in response to a control signals generated by the processor 240.

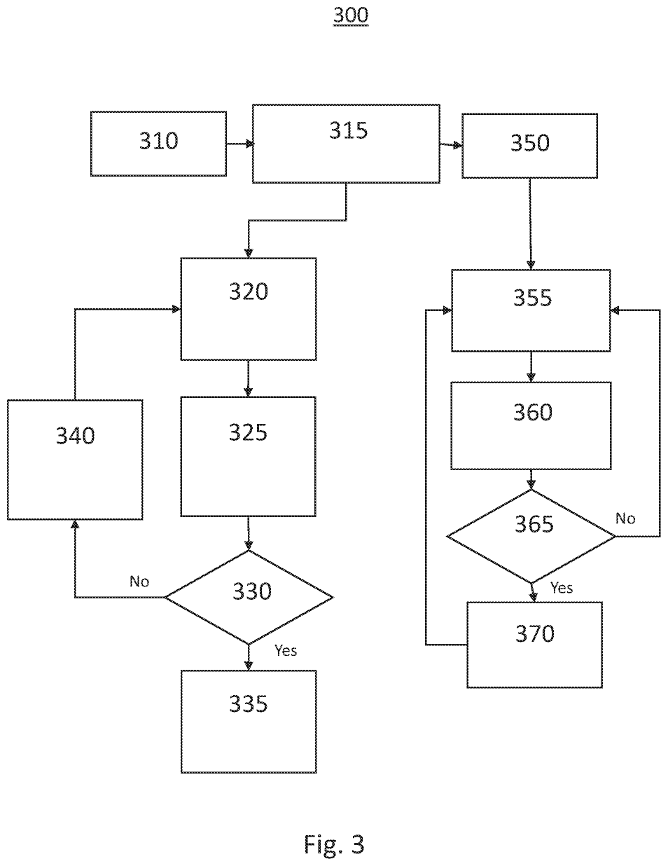

Turning now to FIG. 3, a flow chart illustrating an exemplary implementation of a method 300 for predicting automated driving system disengagement is shown. The method is first operative to receive 310 a route request via a user interface or via a wireless transmission. The route request may be indicative of a destination or may be indicative of a destination with a preferred route. The route request may further be an initiation of an ADAS function, such as adaptive cruise control, in response to a user request via a user interface.

The method is next operative to determine 320 a current location of the vehicle. The method may determine this location in response to a GPS receive output and/or high definition map data or the like. In response to the current location of the vehicle, the method may be operative to generate a route between the current location and the destination in response to stored map data and data received via a wireless network. The map data and the received data may be indicative of roadways, traffic data, weather, construction information, and the like. The route may be divided into route segments wherein the ADAS system is operative to navigate the vehicle through each of the route segments sequentially.

The method is next operative to simultaneously perform an ADAS operation 320-340 and a predictive navigational algorithm 350-370. In performing the ADAS operation 320-340, the method is operative to detect 320 vehicles, other objects and the environment proximate to the vehicle. The method is then operative to calculate a motion path 325 for the next route segment in response to the detected objects and environment, the map data and the received data. The method is then operative to determine 330 a disengagement score in response to the motion path and additional data. If the disengagement score exceeds a threshold level, the method is operative to initiate 335 a take over function in order for the driver to take over control of the vehicle. If the disengagement score does not exceed the threshold level, the method is then operative to control 340 the vehicle in order to navigate the motion path for the upcoming segment. The method is then operation to return to detection 320 of objects and environment in the next segment.

In parallel with the ADAS operation 320-340, the method is further operative to perform a predictive navigational algorithm 350-370 in order to predict if a disengagement event may be likely in an upcoming route segment. The method is operative to receive 350 data and/or a simulation model generated from crowdsourced data related to the upcoming route segments. The method is next operative to simulate 355 a virtual traverse of the upcoming segment in order to predict a disengagement event. In an exemplary embodiment, using the received data 350 for the upcoming route segment, the method is operative to build an FHMM model using features such as weather, road segment, road type, map version, construction, ambient traffic, and road material. This model may be used to capture transitions between feature states along the road segment and state changes dependent upon those features.

In response to the simulation, the method is next operative to generate 360 a score indicative of the likelihood of a disengagement event occurring in the upcoming route segment. The method then compares 365 this score to a threshold value. If the score does not exceed the threshold value, the method returns to simulate the next route segment in the route. If the score exceeds the threshold value, the method is operative to generate 370 a user warning indicative of the disengagement event. The user warning may be displayed via a user interface and may be indicative of a probability, or likelihood, of the disengagement event occurring and the distance to the disengaging event. For example, the user interface may be a plurality of light emitting diodes which change color in response to the probability of the disengagement event occurring and/or the distance to the probable disengagement event. The method may couple this user warning, score and/or probability and location to the ADAS or the vehicle control system for use by the ADAS. The method may then be operative to simulate 355 the next segment wherein the number of route segments simulated ahead of the vehicle location may be determined dynamically by, for example, distance and speed, or another design requirement.

Additionally, the disengagement information and/or prediction information may be sent to a server via wireless transmission to a central server when either the disengagement state changes or a certain distance/time has elapsed. If the state has changed from engaged to disengaged, an efficient learning algorithm on the central server may updates a state transition model in the data to be transmitted to other vehicles expecting to navigate the route segment. A cloud application on the central server may simulate a vehicle driving down learned virtual road model to determine if state change likely. The cloud algorithm may use the Forward-Backward algorithm for the FHMM to perform belief propagation prediction on the next n road segments where n can be determined dynamically by, for example, distance and speed. Because of the factorial nature of the FHMM, the cloud model may use partial knowledge to make predictions about state-change likelihoods on road segments which haven't previously been encountered. If the cloud application determines that a disengagement is likely in response to segment conditions, the could application may update the information supplied to the vehicle indicating the probability of the disengagement event.

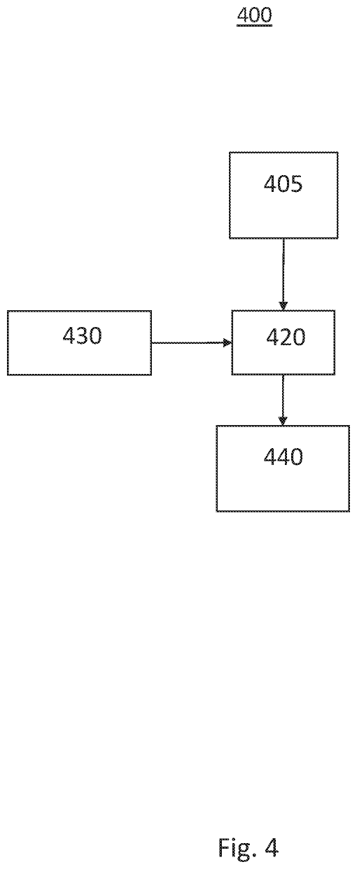

Turning now to FIG. 4, a block diagram illustrating another exemplary implementation of a system 400 for predicting automated driving system disengagement in a vehicle is shown. The system may be an advanced driver assistance system for controlling a host vehicle having a receiver 410, a processor 420, a user interface 430, and a vehicle controller 440.

The receiver 410 may be a radio frequency transceiver, such as a cellular network device, operative to transmit and receive data over a wireless network, such as a cellular data network, to a remote server. In this exemplary embodiment, the receiver 410 is operative to receive a data indicative of an assisted driving system disengagement event provided by a first vehicle. The data may be generated in response to a large number of events detected and transmitted by a plurality of vehicles. Alternatively, the data may be a model generated in response to a number of disengagement events detected by a plurality of vehicles. The model may then be used to predict a disengagement event in response to a host vehicle dynamic. In an exemplary embodiment, a disengagement event is determined in response to a driver take over event provided by the first vehicle. In another exemplary embodiment, the disengagement event is determined in response to a request by an ADAS.

The exemplary system 400 further includes a processor 420 operative to simulate an ADAS algorithm over a second route segment to generate a simulation result, the processor being further operative to predict a predicted disengagement event within the second route segment in response to the data and the simulation result and to generate a warning control signal in response to the predicted disengagement event. The processor 420 may be further operative to generate a route in response to a destination and a host vehicle location and to determine the first route segment and the second route segment in response to the route and to generate a first motion path in response to the first route segment and to couple the first motion path to the vehicle controller 440 for controlling the vehicle over the first route segment. In an exemplary embodiment where an ADAS is not engaged, the processor 420 may be further operative to prevent an engagement of an ADAS function during the second route segment in response to the predicted disengagement event.

The exemplary system 400 may further include a user interface 430 to present a user alert of the predicted disengagement event in response to the warning control signal before the host vehicle reaches the second route segment. The user interface 430 may be a display screen within a vehicle cabin, may be one or more light emitting diodes, a haptic seat, and/or an audible alarm.

In an exemplary embodiment, predicted disengagement event may be predicted using a factorial hidden Markov model. The factorial hidden Markov model may be trained using crowdsourced data collected from an automated driving fleet facilitating finding micro patterns at the road segment level, and macro patterns independent of location. The processor 420 is operative to simulate the operation of a virtual vehicle along a route segment and scoring all the models. Factorial formulation allows for inference on road segments which have not previously been encountered.

The system may further include a vehicle controller 440 operative to control a host vehicle over the first route segment in response to an ADAS algorithm, such as an adaptive cruise control algorithm. The predicted disengagement event is predicted using a factorial hidden Markov model using the data and a current observation data from the vehicle controller 440. The vehicle controller may be operative to transmit current observation data to the processor 420 and to receive control instructions from an ADAS controller. In an exemplary embodiment, the processor 420 is also the ADAS controller. The vehicle controller may control the host vehicle by controlling a steering controller, brake controller, and/or throttle controller and may receive data from an inertial measurement unit.

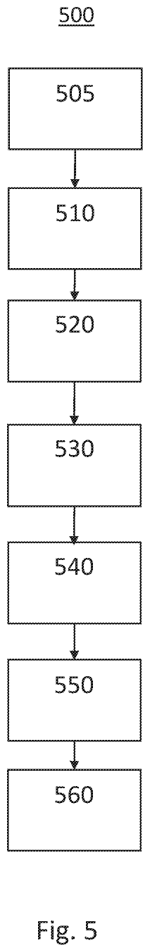

Turning now to FIG. 5, a flow chart illustrating an exemplary implementation of a system 500 for predicting automated driving system disengagement in a host vehicle is shown. The exemplary method 500 is first operative to calculate 510 a route between a host vehicle location and a destination. The host vehicle location may be determined in response to a global positioning system measurement indicative of a current location of the host vehicle. The host vehicle location may be further determined in response to map data stored within a memory within the host vehicle. The destination may be determined in response to a user input or in response to a signal received via a wireless network. The route may be calculated using map data, current traffic, weather, user preferences, vehicle characteristics and the like.

The method is next operative to segment 520 the route into at least a first route segment and a second route segment. The route may be segmented into a number of segments, wherein a segment length may be determined in response to a host vehicle speed, a host vehicle location, road characteristics and road conditions. In this exemplary embodiment, the first second and the second segment may be separated by an additional plurality of segments wherein the number of the additional plurality of segments may be established in response to a host vehicle speed, a host vehicle location, road characteristics and road conditions such that a sufficient amount of time may be provided between a disengagement event warning and a driver safely resuming driving operations.

The method is next operative to generate 530 a first motion path for the first route segment and controlling the host vehicle over the first route segment. The first motion path is generated by an ADAS algorithm and is a path in which the host vehicle will be controlled through the first route segment. The first motion path is generated in response to current host location, destination, detection proximate objects, map data, and the like.

The method next generates 540 a second motion path for the second route segment and simulating a simulated host vehicle operation over the second route segment. The method is then operative to predict 550 a disengagement event in response to the simulated host vehicle operation over the second route segment.

The method then provides 560 a driver alert indicative of the disengagement event while controlling the host vehicle over the first route segment. The driver alert may be indicative of a location of the disengagement event and or a probability of the disengagement event. Prediction of the disengagement event may be performed by determining a probability of the disengagement event and comparing the probability to a threshold level wherein the probability exceeds the threshold level.

The method may further include receiving 505 an event data indicative of a prior disengagement event within the second route segment and wherein the disengagement event is predicted in response to the prior disengagement event, the host vehicle location and a host vehicle speed. The event data may be a simulation model for predicting a disengagement event wherein the model was generated in response to crowdsourced ADAS operational state transitions compiled from a plurality of vehicles. In an exemplary embodiment, the disengagement event may be predicted in response to a factorial hidden Markov model and the host vehicle location and a host vehicle speed. In another exemplary embodiment, the disengagement event is predicted in response to a factorial hidden Markov model generated in response to a plurality of prior disengagement events within the second route segment. The predicting of the disengagement event may further be performed in response to a map data, the host vehicle location, and a host vehicle speed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus comprising:
a receiver operative to receive a data indicative of an assisted driving system disengagement event provided by a first vehicle;
a processor operative to simulate an assisted driving system algorithm over a second route segment to generate a simulation result, the processor being further operative to predict a predicted disengagement event within the second route segment in response to the data and the simulation result and to generate a warning control signal in response to the predicted disengagement event; and
a user interface to display a user alert of the predicted disengagement event in response to the warning control signal before the host vehicle reaches the second route segment.

2. The apparatus of claim 1 wherein the predicted disengagement event is predicted using a factorial hidden Markov model.

3. The apparatus of claim 1 wherein the predicted disengagement event is predicted using a factorial hidden Markov model using the data and a current observation data from the vehicle controller.

4. The apparatus of claim 1 including a vehicle controller operative to control a host vehicle over a first route segment.

5. The apparatus of claim 4 wherein the processor is further operative to generate a route in response to a destination and a host vehicle location and to determine the first route segment and the second route segment in response to the route and to generate a first motion path in response to the first route segment and to couple the first motion path to the vehicle controller for controlling the vehicle over the first route segment.

6. The apparatus of claim 1 wherein the processor is further operative to prevent an engagement of an assisted driving function during the second route segment in response to the predicted disengagement event.

7. The apparatus of claim 1 wherein the data indicative of the assisted driving system disengagement event is determined in response to a driver take over event provided by the first vehicle.

8. A method performed by a processor comprising:
calculating a route between a host vehicle location and a destination;
segmenting the route into at least a first route segment and a second route segment;
generating a first motion path for the first route segment and controlling the host vehicle over the first route segment;
generating a second motion path for the second route segment and simulating a simulated host vehicle operation over the second route segment;
predicting a disengagement event in response to the simulated host vehicle operation over the second route segment; and
providing a driver alert indicative of the disengagement event while controlling the host vehicle over the first route segment.

9. The method of claim 8 wherein the driver alert is indicative of a location of the disengagement event.

10. The method of claim 8 wherein the driver alert is indicative of a probability of the disengagement event.

11. The method of claim 8 wherein the predicting of the disengagement event is performed by determining a probability of the disengagement event and comparing the probability to a threshold level wherein the probability exceeds the threshold level.

12. The method of claim 8 further including receiving an event data indicative of a prior disengagement event within the second route segment and wherein the disengagement event is predicted in response to the prior disengagement event, the host vehicle location and a host vehicle speed.

13. The method of claim 8 wherein the disengagement event is predicted in response to a factorial hidden Markov model and the host vehicle location and a host vehicle speed.

14. The method of claim 8 further wherein the controlling the host vehicle over the first route segment is performed in response to the first motion path and an advanced driving assistance system algorithm.

15. The method of claim 8 wherein the disengagement event is predicted in response to a factorial hidden Markov model generated in response to a plurality of prior disengagement events within the second route segment.

16. The method of claim 8 wherein the predicting of the disengagement event is performed in response to a map data, the host vehicle location, and a host vehicle speed.

17. The method of claim 8 wherein a location of the second route segment is determined in response to the host vehicle location and a host vehicle speed.

18. An advanced driver assistance system for controlling a host vehicle comprising:
a vehicle controller to control a host vehicle in response to a first motion path;
a receiver operative to receive a simulation model for simulating a second motion path;
a processor for determining a first route segment and a second route segment, for generating the first motion path in response to the first route segment, for simulating the second motion path according to the simulation model to generate a disengagement probability and for predicting a disengagement event in response the disengagement probability, and for generating an alert signal in response to the disengagement probability; and
a user interface for provide a disengagement warning to a host vehicle operator in response to the alert signal wherein the disengagement warning is indicative of the disengagement probability and a location of the second route segment.

19. The advanced driver assistance system for controlling the host vehicle of claim 18 wherein the simulation model is a factorial hidden Markov model and the disengagement probability is predicted in response to the factorial hidden Markov model generated in response to a plurality of prior disengagement events within the second route segment.

20. The advanced driver assistance system for controlling the host vehicle of claim 18 wherein the simulation model is indicative of a prior disengagement event within the second route segment and wherein the disengagement probability is predicted in response to the prior disengagement event, a host vehicle location and a host vehicle speed.
